(19) United States
(12) Patent Application Publication
(10) Pub. No.: US 2023/0083053 A1
(43) Pub. Date: Mar. 16, 2023

(54) LASER INSCRIPTION FOR GEMSTONES

(71) Applicant: Gemological Institute of America, Inc. (GIA), Carlsbad, CA (US)

(72) Inventors: Zhen WANG, Secaucus, NJ (US); Benjamin VALLIANT, Nutley, NJ (US); Hiroshi TAKAHASHI, Fort Lee, NJ (US); Mehdi TOOSI, Clifton, NJ (US)

(21) Appl. No.: 17/943,136

(22) Filed: Sep. 12, 2022

Related U.S. Application Data
(60) Provisional application No. 63/243,696, filed on Sep. 13, 2021.

(51) Int. Cl. B23K 26/03; B23K 26/08; B23K 26/359

(52) U.S. Cl. CPC B23K 26/032; B23K 26/0861; B23K 26/359; B23K 2103/52

(57) ABSTRACT

Systems and methods here may be used for a laser inscriber or engraver of a gemstone using software feedback loops and multiple cameras to auto focus the system and automate the inscription.

### CROSS REFERENCE TO RELATED APPLICATION

This application is related to and claims priority from U.S. Provisional Application No. 63/243,696 filed on Sep. 13, 2021, the entirety of which is hereby incorporated by reference.

### FIELD

The field includes laser systems and methods to inscribe or engrave gemstones.

### BACKGROUND

Marking gemstones with permanent inscriptions, etchings, and/or engravings have been used to help identify stones and apply logos. Lasers are currently used to etch many various things including gemstones, however, current laser setups have certain drawbacks that need to be improved upon. Such drawbacks of current systems include unwieldy systems where the beam spots need to be well controlled, and the resulting inscriptions are not clear or accurate. Such systems also require high maintenance efforts and can take a long time to repair. These drawbacks require new and improved systems and methods, described herein.

### SUMMARY

Systems and methods here may be used to ablate gemstones using laser inscribing systems and methods. Systems and methods here include laser inscribing a gemstone, the method including by a computer with a processor and memory, the computer in communication with a first light source and a second light source, a top camera, a side camera, x, y, and z motors configured to move a stage in communication with a holder configured to hold the gemstone, and a laser generator, wherein the gemstone includes a girdle to be inscribed, by the computer, causing the first light source to be directed at the gemstone in the holder from a side-profile, by the computer, causing the second light source to be directed at the gemstone in the holder from a girdle top-view profile, by the computer, capturing a top image of the gemstone in the holder by the top camera with a top camera optical filter that is configured between the second light source and the stage, by the computer, capturing a side image of the gemstone in the holder by the side camera with a side camera optical filter that is configured between the first light source and the stage, by the computer, using the side image captured by the side camera to map a girdle profile for an inscription by utilizing edge detection algorithms, wherein the inscription is made of a plurality of inscription spots, by the computer, determining an x-y-z coordinate of each inscription spot for the inscription based on a trajectory path determined using the top image and a z-offset determined using the side-view image, by the computer, causing the x, y, and z stage motors in communication with the holder to move the holder and thereby the gemstone to align each calculated x-y-z coordinate of the inscription spots to a respective laser focusing plane, by the computer, while causing the x, y, or z stage motor to move the holder and thereby the gemstone, causing the laser to emit a laser beam directed at each respective inscription spot aligned with the laser focusing plane, wherein the laser beam is focused on each respective laser focusing spot by an objective lens, and wherein each respective inscription spot is substantially equally spaced from one another.

In some examples, the top camera optical filter and side camera optical filter is a bandpass filter, a shortpass filter, or a longpass filter. In some examples, determining the z-offset using the side-view image includes determining a target inscription spot on the girdle of the gemstone to align with the laser focal plane. In some examples, by the computer, mapping the gemstone girdle after capturing the top image and the side image of the gemstone, causing alignment of each of the x,y,z coordinates of each inscription spot, with the laser focal plane by instructing the x-y-z stage motors to move the holder and thereby the gemstone, wherein for each inscription spot, the x-y stage motor instructions follow a predetermined trajectory path and z stage motor instructions are determined with respect to the girdle profile using the side image. In some examples, the x-y-z coordinates of each inscription spot are pre-determined based on a reference calibrated to a size of the gemstone.

In some examples, the laser is a solid-state/excimer laser. In some examples, further comprising, by the computer, modulating each inscription spot by a width by modifying the z-offset by controlling a motorized iris open and close, inserting and optical attenuator module or utilizing a filter in a path of the laser beam. In some examples, by the computer, modulating each inscription spot for the inscription by a width by modifying a laser power variation by controlling a motorized iris open and close, inserting an optical attenuator module, or utilizing a filter in a path of the laser.

Methods and systems described here include laser inscribing a gemstone, the system including a computer with a processor and memory, the computer in communication with a first light source and a second light source, at least one motor coupled to a holder configured to hold the gemstone, and a laser generator to create an inscription on the gemstone, wherein the first light source is configured to be directed at the gemstone in the holder from a side-view, wherein the second light source is configured to be directed at the gemstone in the holder from a girdle top-view, a top camera configured with a top camera color filter that only transmit light from the second light source and to capture a top image of the gemstone in the holder, a side camera configured with a side camera color filter that only transmit light from the first light source and to capture a side image of the gemstone in the holder, wherein the computer is configured to utilize the captured side image to map a side view girdle profile of the gemstone and calculate a relative motor movement to align each spot along the inscription with a laser focal plane, wherein the computer is further configured to cause the laser generator to generate a laser beam at the gemstone in the holder, and the relative motor movement of the gemstone in the holder aligns the spots along the inscription at substantially equal spacing from one another along the inscription.

### BRIEF DESCRIPTION OF THE DRAWINGS

For a better understanding of the embodiments described in this application, reference should be made to the Detailed Description below, in conjunction with the following drawings in which like reference numerals refer to corresponding parts throughout the figures.

FIG. 1 is an illustration of an example inscription using certain aspects described herein;

FIG. 2 is an illustration of an example inscription arrangement using certain aspects described herein;

FIG. 3 is an illustration of an example laser graph using certain aspects described herein;

FIG. 4 is an illustration of an example laser focus system with certain aspects described herein;

FIG. 5 is an illustration of an example system with certain aspects described herein;

FIG. 6 is an illustration of an example system with certain aspects described herein;

FIG. 7 is an illustration of an example system with certain aspects described herein;

FIG. 8 is an illustration of example holders with certain aspects described herein;

FIG. 9 is an illustration of an example focus plane arrangement using certain aspects described herein;

FIG. 10 is an illustration of an example system with certain aspects described herein;

FIG. 11 is a flow chart example of steps to be used in certain aspects described herein;

FIG. 12 is an illustration of an example modulated inscriptions with certain aspects described herein;

FIG. 13 is an illustration of an example networked system with certain aspects described herein;

FIG. 14 is an illustration of an example User Interface with certain aspects described herein; and

FIG. 15 is an illustration of an example computing system with certain aspects described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the particular embodiments. In other instances, well-known data structures, timing protocols, software operations, procedures, and components have not been described in detail so as not to unnecessarily obscure aspects of the embodiments herein.

Overview

Systems and methods here may be used for ablating gemstones with laser beams on the surface, and/or below the surface of gemstones. Such inscription may be used to inscribe a number, word, logo, QR code, barcode, secondary encryptions, and/or three dimensional images in the gemstone for labeling and/or identification purposes, as well as for customizing gemstones. Such inscriptions may be visible with the naked eye, or hard to see with a naked eye, but under magnification provide information that may be used for tracking and identifying gemstones. Such ablation inscriptions may be hard to change and/or mimic by third parties, especially those under the surface. By using the systems and methods here, clear inscriptions may be made on or in gemstones of a multitude of shapes and colors including diamonds.

For example, by using the systems and methods described here, an inscription of 5 um line at a contour repeatability of +/−0.5 .tm may be made, with an inscription time for a single character less than 1 second, the system may be isolated from external vibration and environmental dust using user-friendly software with access to other systems resulting in easy operation and quick maintenance. Such an inscription may be easy for a computerized camera system to detect and analyze for tracking, tracing, identifying, etc. as described herein when used with databases for storing and retrieving data associated with the gemstones and inscribed indicia.

Laser Inscription Examples

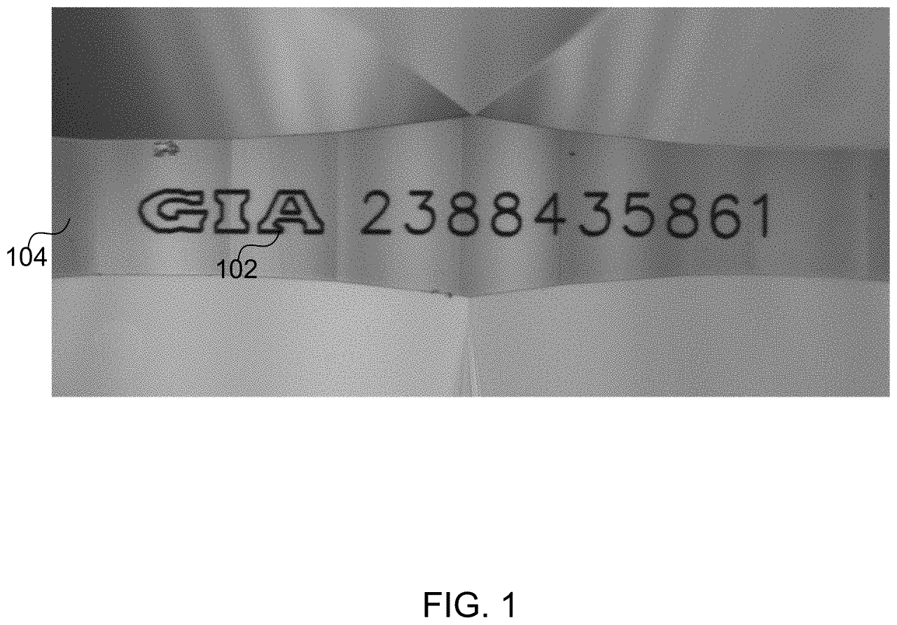

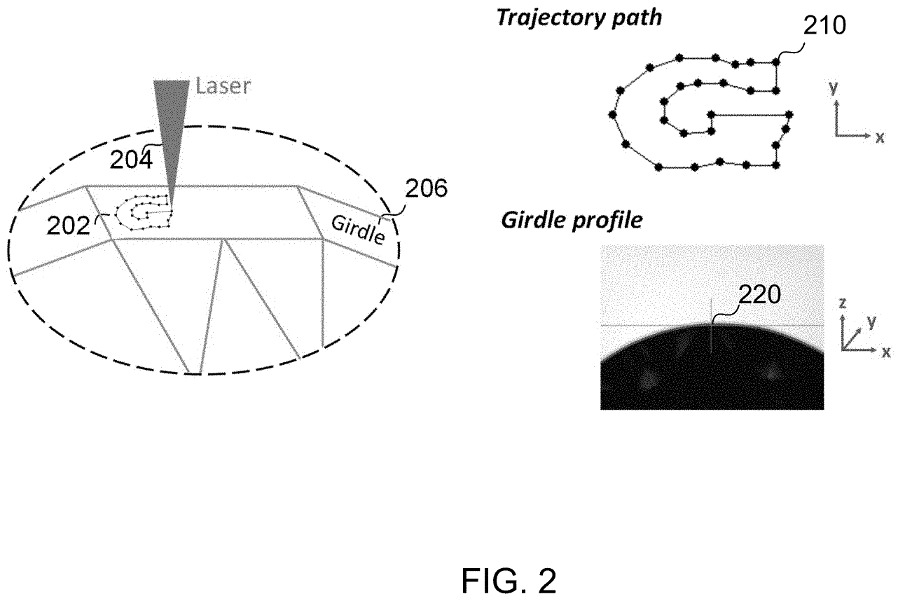

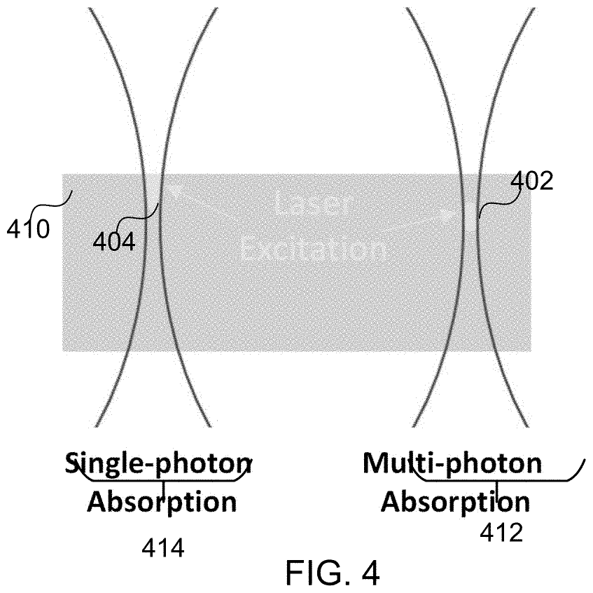

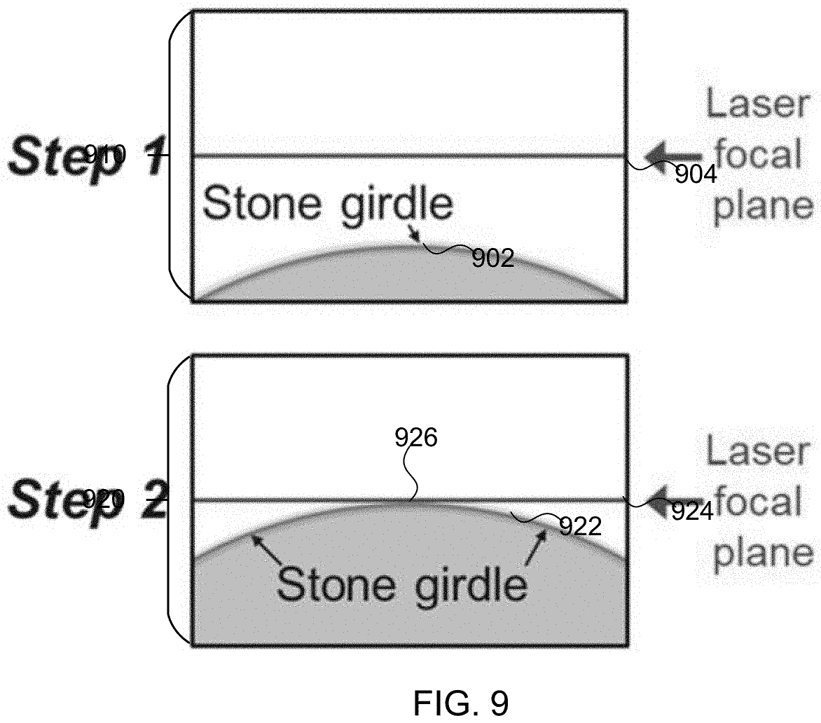

In systems and methods described herein, an excimer laser or a solid-state laser may be utilized to inscribe 102 gemstones 104 such as the inscription shown in FIG. 1. The example of FIG. 1 shows the inscription 102 on the girdle of a cut diamond, however, such inscriptions may be made in any location on a cut diamond, the girdle example being non-limiting. In some examples, by tuning the laser frequency and pulse energy, the ablated patterns may be readable black inscriptions before cleaning, and be located on the surface of a gemstone or below the surface of a gemstone as described herein. FIG. 2 shows an example of the laser beam 204 focusing energy on the girdle 206 of a gemstone and ablating the gemstone one spot or point 202 at a time, according to instructions provided by and to the computer software in communication with the hardware laser system. The software may be programmed with x, y, and z coordinates for all the inscription spots or points accomplished by the laser focus spot as described herein. In some examples, a trajectory path from one inscription point to the next 210 may be programmed into the system to create any particular shape, pattern, or image is inscribed, one point at a time. By ablating multiple spots or points 202, patterns or shapes may form in the diamond, either visible to the naked eye, or small enough to require magnification to see. This arrangement allows for both programming of the x, and y coordinates to make two dimensional designs, but optionally z dimension depths from the gemstone surface 220 as shown as example from a girdle profile as well for three dimensional designs at different depths beneath the surface of a gemstone. FIG. 9 explores the girdle profile and laser focal plane in more detail. FIG. 4 examines in more detail, the surface and sub surface examples of ablation utilized here. In examples where specific tracking codes, logos, and designs are used, spacing between a logo and font may be fixed for better reproducibility and readability for inscription of codes that may be readable by camera, laser, or other detection systems.

Examples of lasers used for such systems may include a gas laser or a solid-state laser, an ArF excimer laser may be used as a preferred embodiment example herein. Such an excimer laser (ArF laser) used for this application may have a wavelength of 193 nm which is a deep ultraviolet (DUV) laser. With the photon energy above 6 eV, excimer laser can be directly absorbed by and inscribe most types of diamond and gemstone samples.

A solid state laser is a laser with a gain medium that is a solid. This may be a different gain medium than a liquid used in a dye laser or gas used in gas lasers. Utilization of such a solid state arrangement would avoid periodic gas refills and provide a maintenance free system. Also, a solid state laser may not use toxic gas, such as in an excimer laser which may have limitations to be used in full-automation process, such as the need for room ventilation when in use. As described herein, solid-state lasers in the inscribing systems may help to achieve full-automation as well.

Solid State Laser may be used are lasers with Nanosecond/Picosecond/Femtosecond pulse duration and at ultraviolet/visible/near-infrared wavelengths. For example, picosecond laser at 355 nm wavelengths and femtosecond laser at the 515 nm wavelength, and etc. The above wavelengths are examples only, other wavelengths besides above examples are also utilized as well. Multi-photon absorption may be needed for inscription to inscribe a diamond which may have a wide bandgap of 5.47 eV as discussed further in FIG. 4.

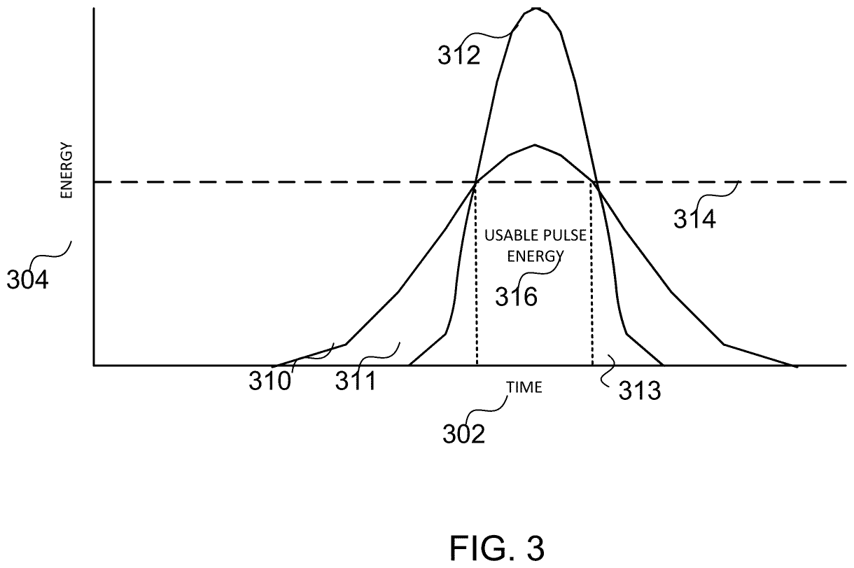

Selecting a proper laser beam pulse and time may allow for more accurate laser inscriptions. FIG. 3 shows an example of a laser beam pulse chart of energy on the y axis 304 and time on the x axis 302. A short pulse 312 in time may provide more usable energy 316 than a longer pulse 310. The longer pulse 310 is shown with more waste energy 311 that does not meet the ablation threshold 314 to provide the residual mark required to inscribe the target gemstone. The shorter pulse 312 has a higher usable energy above the ablation threshold 314 than the longer pulse 310. The shorter pulse 312 has less waste energy 313 than the longer pulse 310.

An excimer laser may mainly be used to inscribe on the surface of a gemstone in contrast to a solid-state laser which may be used to inscribe on the surface of a gemstone and/or below the surface of the gemstone. For a solid-state laser, as shown in FIG. 4, by using system systems in inscribing at or below the surface of a gemstone, a laser penetration depth increase by increasing wavelength. The left example 414 shows a single-photon absorption with the laser excitation 404 on the surface of the gemstone 410 and the right example 412 shows examples of non-linear, multi-photon absorption to enable sub-surface marking by an ultrafast solid state laser as described herein. The site of the laser excitation is the ablation point that alters the gemstone crystal and creates micro fractures in that region to create the inscription spot or point as described herein for example in FIG. 2.

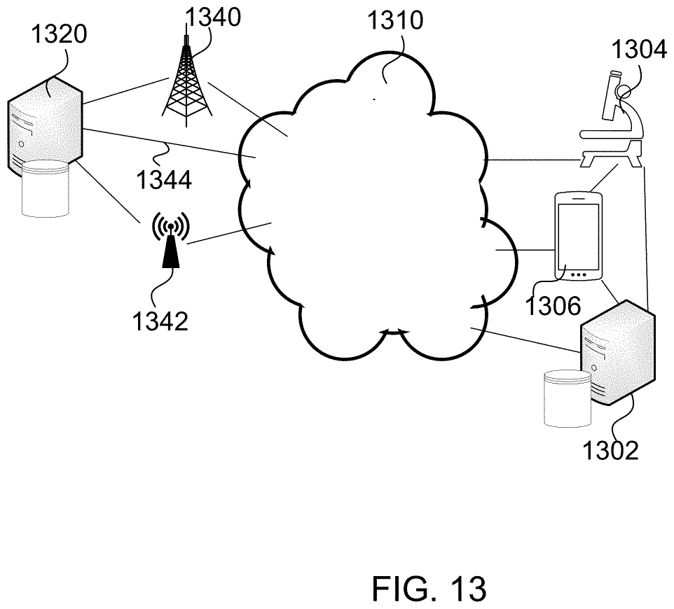

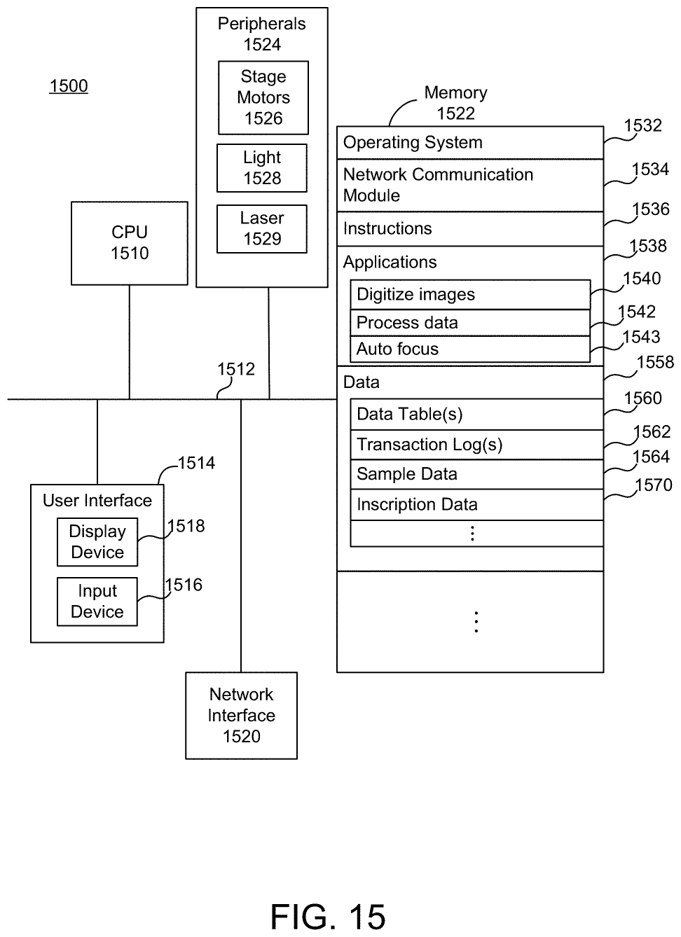

Such laser systems as described herein may include or be in communication with computer systems such as but not limited to those described in FIGS. 13 and 15. Such computer systems may be configured to control the laser parameters, cause generation of the laser beam, cause movement by the various motors that hold the gemstone to aim the laser beam at the inscription spot or point, and/or control capturing digital images with the camera(s) to analyze for alignment and inscription completeness.

Hardware Setup Examples

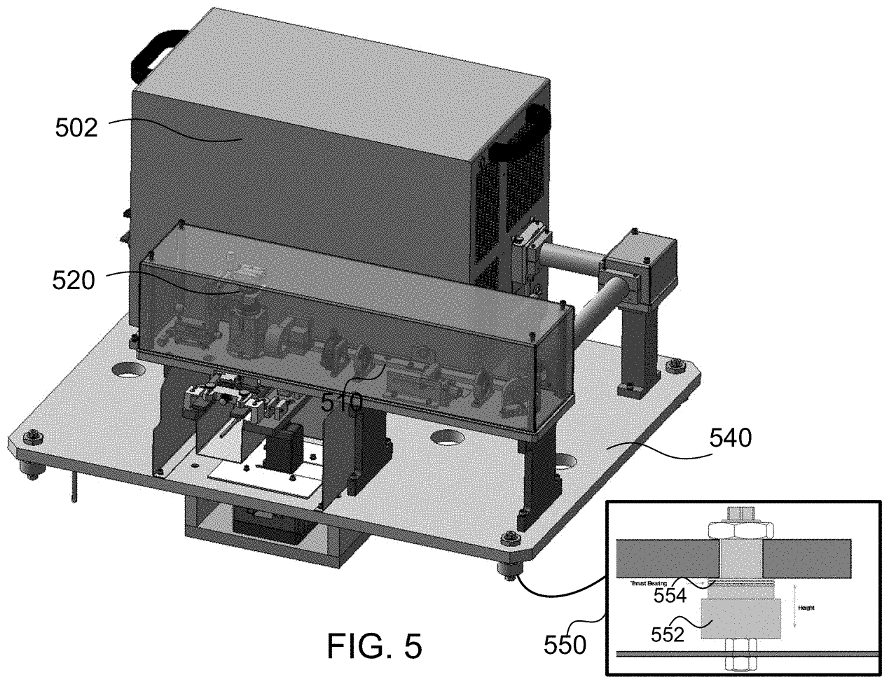

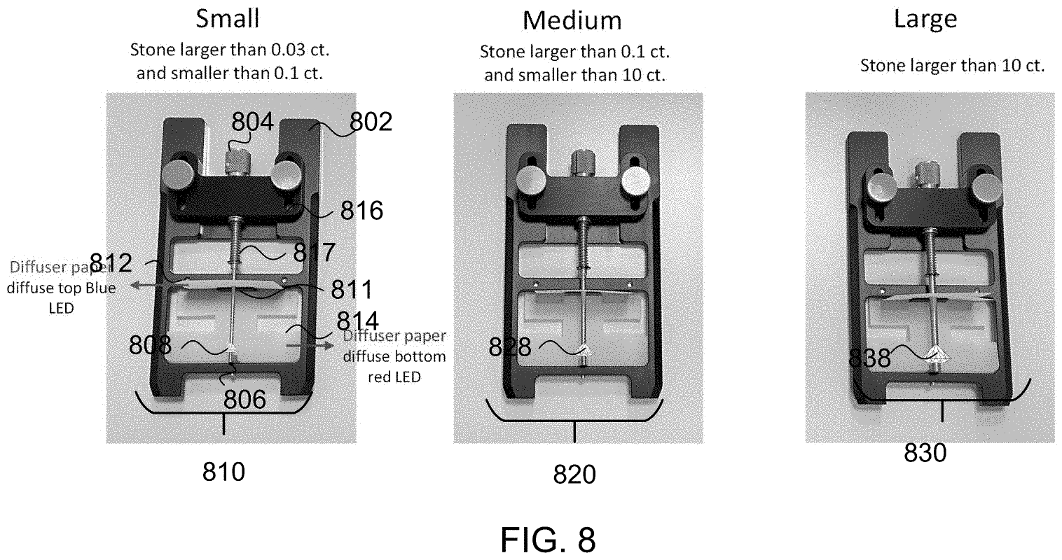

FIG. 5 shows an example laser inscription arrangement with the laser generator 502 directing a beam 510 at the stage or holder 520 where a sample gemstone may be arranged for inscribing. In some examples, the optical table 540 may be suspended or supported on silicon Vibration-Damping Sandwich Mounts 550 with Threaded Stud 552. Each damper may include a radial thrust bearing 554 to act as a level adjustment as well as vibration damper. FIG. 8 describes the holder examples in more detail, below.

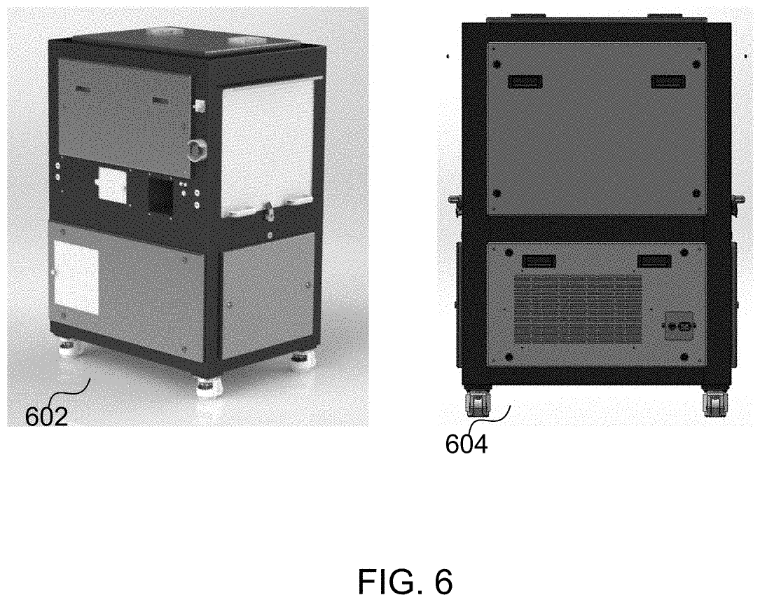

FIG. 6 shows such an enclosed system perspective 602 and side 604. In such an arrangement, the hardware, for example in FIG. 5, is kept inside the enclosure to keep the inside clean and also to isolate sensitive optics from external vibration during the inscription process. In the example, an enclosed system may prevent dust from polluting the inscription processes utilizing at least one of weather stripping seals on all panel openings, switching off the internal fan when automated access door is open. Some examples include using a filter with Filter Performance Rating (FPR) such as a FPR6 or better, and/or a high efficiency particulate air (HEPA) filter.

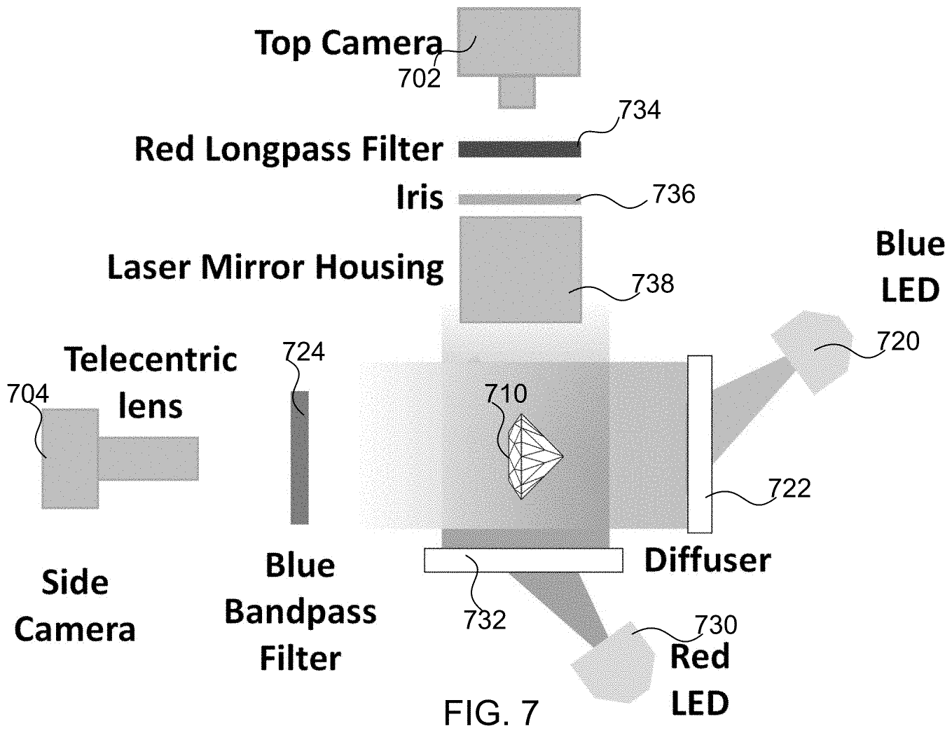

FIG. 7 shows an example hardware abstract of the equipment which may be utilized to employ the methods described herein, and be included in the setup of FIG. 5. This setup allows the system to capture and analyze two images of the gemstone: a top-view and a side-view image of the target gemstone. The side-view image would capture a profile of the diamond girdle (as shown in FIG. 9, 902, and FIG. 2, 220, as a girdle of a gemstone although any portion of a stone may be inscribed, the girdle being only a non-limiting example). This profile edge may be used by the computer systems and software to calculate an offset from laser focus spot for each inscription spot or point. As mentioned, a Z-stage motor may be in communication with the computer systems and configured to move the holder and thereby the gemstone to correlate to the determined offset during the inscription process so that all the programmed characters may be inscribed on the laser focus spot or point, as instructed by the computer systems to create the desired and programmed image or design.

A top camera 702 and side camera 704 (with optional telecentric lens) may be used to line up the stone 710 to be inscribed with illumination of the stone for inscribing coming from a Blue light emitting diode (LED) 720 and Red LED 730, each behind a respective diffuser, one for the blue light 722 and one for the red light 732 aimed at the gemstone 710. FIG. 8 describes the holder examples, below, in which the stone is held but not shown in FIG. 7. By illuminating a gemstone from the back and bottom angles as shown, the stone girdle image is more easily analyzed by the camera and computer systems for more precise inscriptions.

In the example of FIG. 7, a red long pass filter 734 is used between the stone 710 and top camera 702. In the example, an iris 736 is used between the stone 710 and top camera 702. In the example, a laser mirror housing 738 is arranged above the stone. In the example a blue band pass filter 724 is arranged between the stone 710 and side camera 704.

The components in FIG. 7 that may include internal computer systems, or be in communication with computer systems that include but are not limited to, the top camera 702, side camera 704, iris 736, and laser mirror housing 738 as well as motors holding the stone 710 and/or stone holder. Such systems may be used to automatically focus the systems as described herein with feedback loops of images sent to the computer to make adjustments to the motors to move the holder and gemstone as described herein.

Separate blue 720 and red 730 LED light may be used to illuminate the stone 710 for inscribing by inserting different color filters 724, 734 for top 702 and side 704 camera. Lens coupled with the side camera 704 may be used to provide a clear image of the stone 710 girdle, should that be the part of the stone that is inscribed. Utilizing an iris 736 before the top camera 702 as shown in FIG. 7 to clip reflected side light may help increase the depth of view.

Such laser systems as described herein may include or be in communication with computer systems such as but not limited to those described in FIGS. 13 and 15. Such computer systems may be configured to control the laser parameters, cause movement by the various motors, and/or control capturing digital images to analyze for inscriptions.

Gemstone Holder Examples

In some examples, as shown in FIG. 8, a gemstone holder may be used to hold a gemstone for the laser to inscribe thereon. The example stone holder may be used to hold the stone to be inscribed in one place, to keep it from moving during an inscription process and allow an operator to more easily change the stones out from the inscription machine, if multiple stones are already loaded into holders, or stones are swapped out in one holder in rapid succession. Such a holder may also more easily include identifying information for the stone, so that the operator can keep track of which stones to load and inscribe with which indicia.

The holder includes a frame 802 with a spring loaded shaft 804 mounted generally parallel to two of the four sides of the frame, and a fixed end 806 opposite the spring loaded shaft 804. Some examples include a thrust ball bearing and a thrust washer on both side of the spring 817 to facilitate the rotation of the spring loaded shaft 804 and prevent torsional resistance. The example spring loaded shaft 804 may be pulled open by an operator to move the spring loaded shaft 804 relative to the holder frame 802 and released to pinch a sample stone 808 between it and a fixed end 806, held by the spring tension of the spring 817 which is biased to push out and away from the top guide set 816. In the example, the holder includes a top guide set 816 through which the spring loaded shaft runs, with an opening to allow movement or sliding of the spring loaded shaft, for the spring 817 to push out and away from to impart the force of the spring loaded shaft 804 on the gemstone 808 and includes two guide slots and pegs to keep the spring loaded shaft aligned with the fixed end 806 as it opens and closes. The sample stone 808 may be placed on the holder and pinched between the spring loaded shaft 804 and fixed end 806 as the spring loaded shaft 804 is pushes away from the top guide set 816 by spring tension.

FIG. 8 shows the holder securing three different sized stones, small stone 806 at 810, medium stone 828 at 820 and larger stone 838 at 830, as the shafts are relatively small, medium and large to fit the stones. In some examples, a small shaft may be used to hold stones between 0.03 carat and −0.1 carat, the medium shaft may be used to hold stones larger than 0.1 carat and smaller than 10 carats, and the larger shaft may be used to hold stones larger than 10 carats in size. This shows how the same arrangement may secure many sizes of gemstone for analysis. Such a stone holder is useful for inscribing many different parts of a gemstone, but especially helpful for inscribing a girdle on a gemstone.

In some examples, such a holder not only pinches the stone 808 between the spring loaded shaft 808 and the fixed end 806, but may also include a diffusers to diffuse light used to illuminate the gemstone during inscribing process. Diffusers may be added for both top and bottom LEDs which help provide uniform lightning environment and lead to better image quality.

In some examples, this may include a top blue LED diffuser paper 812. In the example of FIG. 8, the diffusers 812, 814 are paper diffusers but could be made of plastic, etched glass, or any other kind of diffuser. The example holder 802 includes a friction fit slot 811 for the top blue diffuser paper 812 to be secured. In some examples, the holder may include diffuser paper 814 to diffuse bottom red LED. Stone holders with different spring loaded shaft 804 shaft sizes may be used to fit different stone sizes.

In use, the arrangement shown in FIG. 8 is then placed in the system, such that the blue LED light shines through the top diffuser paper 812 and the bottom red light shines through the bottom diffuser paper 814 leaving the stone 808 open for the cameras to view from the top and side as shown in FIG. 7 and the laser to inscribe.

In some examples, the gemstone holder 810 may be placed into the inscription system and moved by the motors to allow the laser to inscribe where a software program has directed it. In such examples, a set of stepper motors or electric motors may be used to move the holder and gemstone in the x, y, and z directions while the laser system stays stationary to fire into the stone when the computer commands it to as shown in FIGS. 5 and 7.

Auto Focus Examples

In some examples, the focusing of the system to inscribe a gemstone may be accomplished using an automated computer arrangement including image capture feedback loops tied to the motors that move the holder and thereby the stone to be inscribed. Such an arrangement may utilize the digital camera arrangement of FIG. 7, holder arrangement of FIG. 8 and a computerized feedback loop with the laser system to automatically determine, using decision algorithms in the computers software, the best focus spots in the x, y and z coordinates for the system to ablate the laser etching into the target gemstone as described herein.

In such examples, an auto-focusing function may be used to align a profile edge, such as the girdle profile edge of the gemstone to be inscribed with the laser focal plane 904, 924 automatically using cameras 702, 704 as shown in FIG. 7 and a feedback look to the computer and motors holding the gemstone. In some examples, the auto focus begins when a user selects the auto-focusing function from a user interface of the computerized inscription system. This selection commands the computer to find a highest spot 926 on the stone girdle side silhouette and align it with the laser focusing plane using captured images as described in FIG. 7.

FIG. 9 shows an example side view of a gemstone with the girdle 902, 922 edge in silhouette. Such a side view may be captured by the side image camera 704 in FIG. 7. In Step One 910, the stone girdle 902 is away from the laser focal plane 904. This laser focal plane is the plane at which the laser will fire and focus its energy to ablate and thereby inscribe the target stone. As shown in Step Two 920, with the auto-focusing function, the x-y-z stage motors may position the stone girdle 922 align with the laser focal plane 924. Such an arrangement may be precisely aligned using images captured by the side camera (704 in FIG. 7) of the gemstone and the computer systems analyzing the pixelated digital images, coupled to the motors positioning the stone holder, and thereby the stone into the requested position. By user input as to depth and position, the computer may command the motors to move and thereby position the stone for inscription.

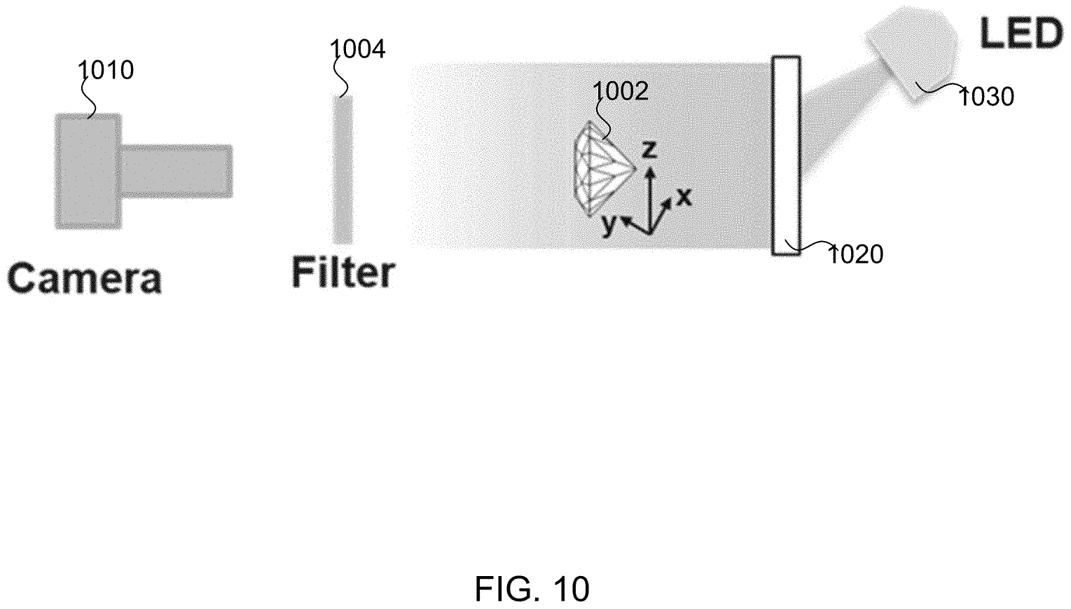

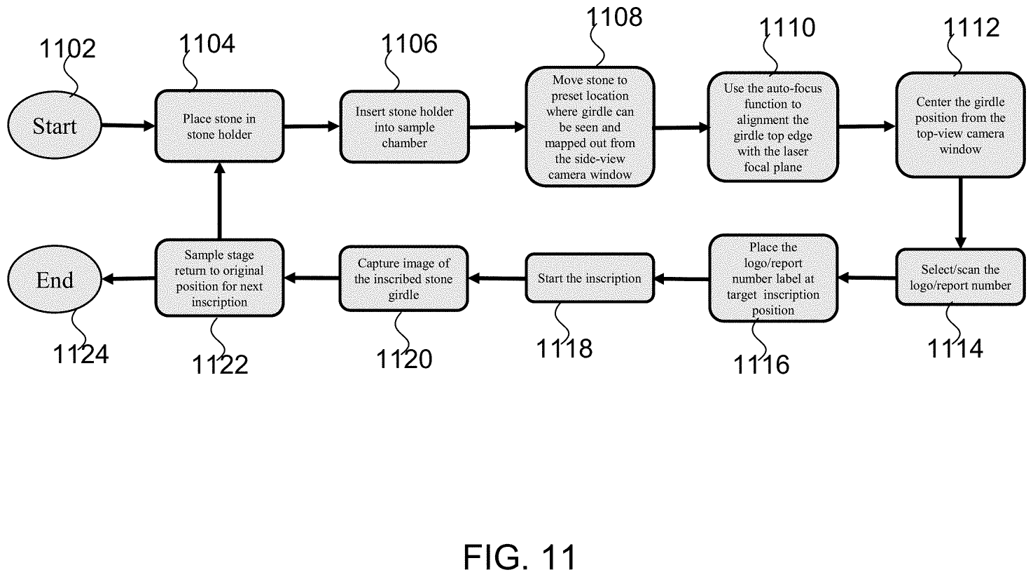

In some examples, preset locations for different size stones may be used. For example, the system may be set to preset or predetermined positions for common stone sizes such as but not limited to: 0.2 ct, 0.5 ct, 1 ct, 3 ct and 5 ct such that the system may more quickly position the sample stone for inscription based on known or estimated sizes of stones that meet the common presets. In such a way, the predetermined inscription spots for a specific sized gemstone may be utilized. After inserting the samples in the stone holder and moved to a preset location, the diamond girdles may be shown in the view of side camera 704 in FIG. 7 and edge of the girdle 922 will be masked (shown as the transparent thick red line). FIG.11 shows the example operation flow chart of the inscription process. As shown in FIG. 10, after a sample stone 1002 is inserted into the stone holder 1104, and then the holder is inserted into the sample chamber 1106, the stone is moved to a preset location where the girdle can be seen from a profile side-view and mapped by the computer 1108 by way of image capture of the side-camera 1010. The auto-focus function may be used to align the girdle top edge with the laser focal plane 1110 (also shown as 220 in FIGS. 2 and 926 in FIG. 9). A center of the girdle position from the top view camera, 1020 in FIG. 10, window may capture an image of the top view 1112. Next, the system may select/scan the logo/report the number viewed 1114. Next, system may place the logo/repot number label at the target inscription position 1116. Next the inscription may be started 1118 by firing the laser generator to send laser beams to the designated spot (404 or 402 in FIG. 4). The system may capture a girdle image to be analyzed by a developed image processing algorithm and the edge detected & mapped out based on the contrast between the stone and whatever background 1020 is in the image 1120. Next, the sample stage may be returned to the original position for next inscription 1122 which may result in the end 1124 if no more inscriptions are needed, or a return to the stone in the holder 1104 to begin the next inscriptions on the next stone. In some examples, a filter 1004 is arranged between the camera 1010 and stone 1002. In some examples, a light source 1030 illuminates the background 1020 as described herein.

Before the inscription, girdle profile 922 will be mapped out by side camera, trajectory path of subsequently inscribed spots on the stone for coordinates 220 in FIG. 2 may be calculated based on the position of logo file on the stone girdle captured by the top camera. With an image processing algorithm and feedback loop, laser inscription 202 in FIG. 2 will be positioned at the laser focus spot which may help ensure good laser focus for the entire curved diamond girdle surface 926 in FIG. 9. During the inscription, targeted inscription spots will be simultaneously aligned with the laser focus spot by a stage/stone holder motion control system with motors.

Such laser systems as described herein may include or be in communication with computer systems such as but not limited to those described in FIGS. 13 and 15. Such computer systems may be configured to control the laser parameters, cause movement by the various motors, and/or control capturing digital images to analyze for inscriptions.

Inscribing Examples

In some examples, patterns such as letters, numbers, bar codes, a QR code, a three dimensional image, logo, picture, pattern, or any other pattern may be inscribed by programming the system to move the target gemstone and fire the laser at specific points in the three dimensional x, y, and z coordinate planes. Again turning to FIG. 2 as an example of the laser focusing energy on the girdle of a gemstone with an inscribed pattern of letters. Such a pattern is achieved during the laser inscription process, when x, y, z positions are programmed and may be adjusted simultaneously, for each spot, x-y follow trajectory path and z follows the girdle profile obtain from side-view camera as described herein.

Using the systems and methods here, any pattern may be similarly inscribed in a target gemstone. See FIGS. 1 and 2 as other examples. And using a digital camera in communication with a computer, such patterns may be captured by the camera and the captured image may be compared to previously stored patterns. In such a way, a gemstone code may be tracked, traced, data regarding it may be stored and retrieved, links to webpages, block chain ledgers, transaction chains or documents, may all be programmed and triggered or actuated by the pattern in the gemstone.

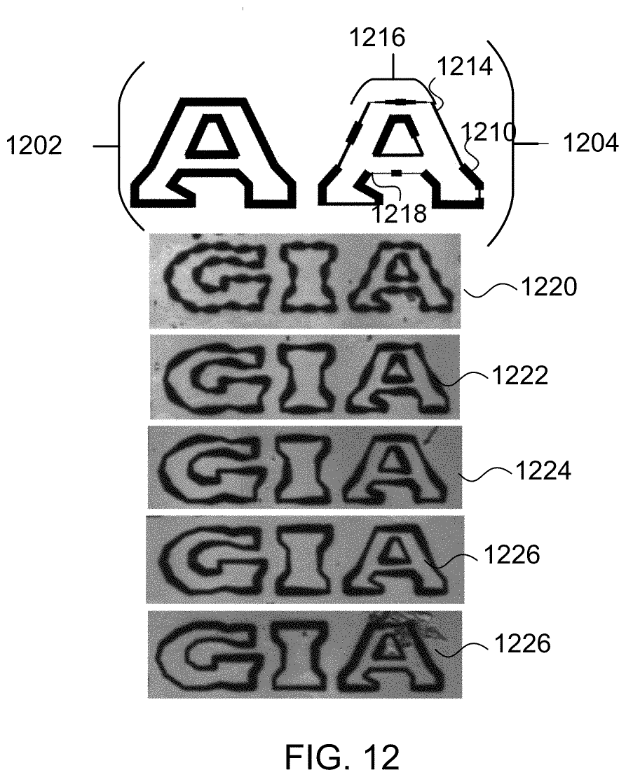

But in some example systems and methods here, a second layer of coding may be used to further enhance the code, aid in encryption, and thwart counterfeits. In some examples, as shown in FIG. 12, the systems and methods described herein may be used to create ablated lines with different thicknesses in patterns. By either modifying the z-offset or controlling the laser power during the inscription, an inscribed line width in a gemstone can be modified or customized. In such a way, what looks like a simple numerical or alpha code may actually include a second layer of encryption that is hard to detect and even harder to counterfeit.

Using the systems and methods described here for example, a letter “A” may be inscribed in a gemstone using the same thickness lines 1202. Such a system may be used for simple coding of patterns like letters and numbers. But optionally, using the example systems and methods here, a letter “A” may be inscribed using different thicknesses of lines in the various parts of the letter 1204. In examples with different thicknesses, some lines are thicker 1210 and in some they are thinner 1214. In some they are gradually thickened 1216, and in some they abruptly change thickness 1218.

The first method for line width modulation can be achieved by changing laser focal spot location. The second method for line width modulation is through laser power vibration. An optical attenuator module or ND filter can be placed in front of the laser beam exit to control the output energy from the laser. A Motorized Iris 736 in FIG. 7 can also be used in the laser beam path to control the input laser energy to the focusing objective lens. For example, GIA logo inscribed by periodically modulating line width are shown in FIG. 12, different modulation frequency were tested and different pattern can be achieved.

In such a way, what may appear to the naked eye as a normal inscription such as a letter “A” 1202, may actually be an encoded, unique inscription pattern 1204 utilizing different thicknesses of lines on different parts of the letter. Such thicknesses may be imaged and stored for later comparison. When scrutinized, a digital image may be magnified and analyzed by a computer for future inscription matching/identification purpose by comparing the later inscription with the known computer controlled inscription parameters such as thicknesses of portions of the pattern. Examples of the same three letters “G” “I” and “A” are shown with different thicknesses of lines such as pulses of thick and thin 1220, thickening and thinning lines 1222, portions of lines that alternate thick and thin 1224, longer alternating thick and thin lines 1226, and half of each letter thick and the other thin 1226.

By storing the inscription line thickness parameters in any of various patters such as but not limited to letters, numbers, shapes, or designs for the specific stone inscribed, along with the different thicknesses of the different portions of the patterns, a computer database may retain the special, second layer of encoded inscription parameters and instructions for each specific stone. These stored parameters may later be used by image capture and matching to confirm the identity of a previously inscribed stone, differentiating from other inscriptions of seemingly the same letters and/or numbers, but with different thicknesses of lines in each or some letters and/or numbers. Such encoding may be difficult for counterfeiters to decipher and detect let alone duplicate. This may help ensure the authenticity to later matches.

The example of a letter “A” in FIG. 12 is merely an example and not limiting in any way. Any kind of pattern or logo, letter or number, could be similarly constructed with lines that are thin or thick on different parts, and imaged and stored as part of the pattern matching systems and methods here.

Example Network

FIG. 13 shows an example where the laser systems 1304 described here are networked to a computer 1302 and computer storage, such as a server computer or back end computer system as described in FIG. 15. A display or local computing system 1306 may be in communication with the laser system 1304 and/or the computing system 1302, camera systems, or any other systems in communication with the computers. Such an arrangement may be used to send and receive data of the inscribing laser, directions for moving the laser, image data from the cameras, and commands to the laser to fire, and holder motors to move the target gemstone, etc.

In some examples, the computers may be in communication with a network such as the Internet 1310 and thereby to other back end resources such as computers 1320 and storage through land lines 1344, cellular 1340 and/or WiFi 1342 type example communication methods.

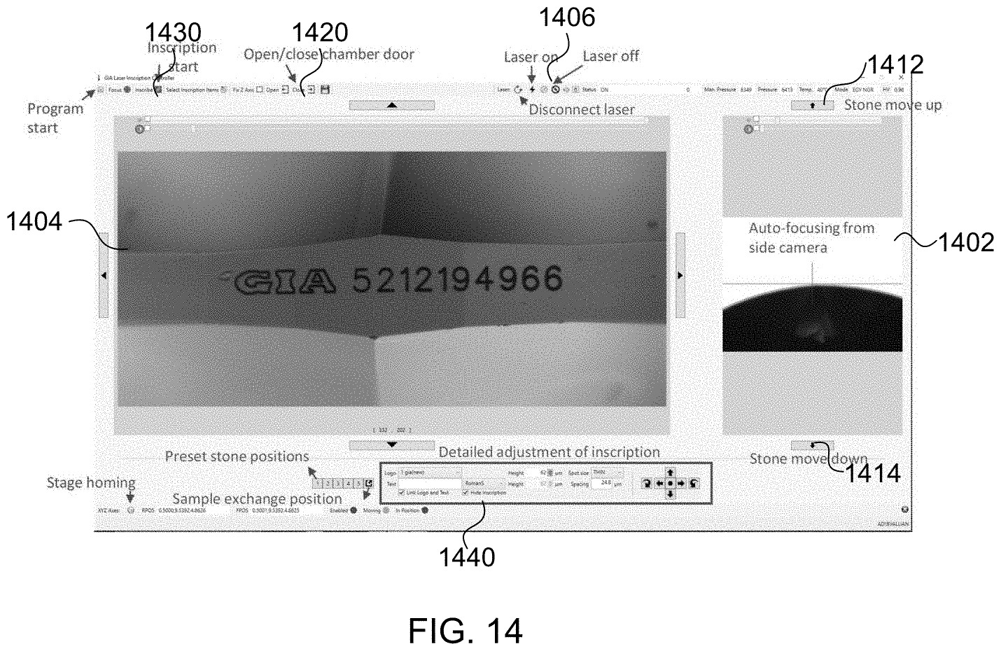

FIG. 14 shows an example User Interface that may be utilized by a user of the computer systems shown in FIGS. 13 and 15 to direct the laser inscription machine to ablate a gemstone with a pattern as described herein. The side girdle view of the camera for auto focus features as described in FIG. 9 is shown in the user interface of FIG. 14 in the right side 1402. Another camera image 1404 is showing the girdle of the sample gemstone. Indications of the laser being on or off are also indicated 1406.

Further, FIG. 14 software interface example shows user directed actions that can affect the systems as described such as software buttons to activate the motors of the stage to move the holder and gemstone up 1412 or down 1414 relatively to the side girdle image for auto-focusing. Such manual overrides could be used alone, or in combination with software the automatically calculates movement of the motors to position the gemstone girdle profile for auto-focusing. Further shown is a chamber door opening and closing indication or control 1420. The inscription start button also appears once the alignment and adjustments are set 1430. And detailed adjustments of the inscription may be manipulated by a user manually using the preset positions and manually entered inscription text, logos, height, spacing, as shown. 1440.

Example Computer Devices

FIG. 15 shows an example computing device 1500 which may be used in the systems and methods described herein. In the example computer 1500 a CPU or processor 1510 is in communication by a bus or other communication 1512 with a user interface 1514. The user interface includes an example input device such as a keyboard, mouse, touchscreen, button, joystick, or other user input device(s). The user interface 1514 also includes a display device 1518 such as a screen that may display a user interface such as the example of FIG. 14 and an input device 1516 such as touch screen, mouse, keyboard, joystick, or other manual input devices. The computing device 1500 shown in FIG. 15 also includes a network interface 1520 which is in communication with the CPU 1520 and other components. The network interface 1520 may allow the computing device 1500 to communicate with other computers, databases, networks, user devices, or any other computing capable devices. In some examples, alternatively or additionally, the method of communication may be through WiFi, cellular, Bluetooth Low Energy, wired communication, or any other kind of communication. In some examples, alternatively or additionally, the example computing device 1500 includes peripherals 1524 also in communication with the processor 1510. In some examples, alternatively or additionally, peripherals include stage motors 1526. In some examples peripherals 1524 may include lights 1528 and laser 1529 to generate the laser beam as disclosed. In some examples, computing device 1500 a memory 1522 is in communication with the processor 1510. In some examples, alternatively or additionally, this memory 1522 may include instructions to execute software such as an operating system 1532, network communications module 1534, other instructions 1536, applications 1538, applications to digitize images 1540, applications to process image pixels 1542, autofocus 1543, data storage 1558, data such as data tables 1560, transaction logs 1562, sample data 1564, inscription data 1570 or any other kind of data.

Conclusion

As disclosed herein, features consistent with the present embodiments may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the embodiments, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the descritions pertains that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a general-purpose processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

What is claimed is:

1. A method of laser inscribing a gemstone, the method comprising:
by a computer with a processor and memory, the computer in communication with a first light source and a second light source, a top camera, a side camera, x, y, and z motors configured to move a stage in communication with a holder configured to hold the gemstone, and a laser generator,
wherein the gemstone includes a girdle to be inscribed;
by the computer, causing the first light source to be directed at the gemstone in the holder from a side-profile;
by the computer, causing the second light source to be directed at the gemstone in the holder from a girdle top-view profile;
by the computer, capturing a top image of the gemstone in the holder by the top camera with a top camera optical filter that is configured between the second light source and the stage;
by the computer, capturing a side image of the gemstone in the holder by the side camera with a side camera optical filter that is configured between the first light source and the stage;
by the computer, using the side image captured by the side camera to map a girdle profile for an inscription by utilizing edge detection algorithms,
wherein the inscription is made of a plurality of inscription spots;
by the computer, determining an x-y-z coordinate of each inscription spot for the inscription based on a trajectory path determined using the top image and a z-offset determined using the side-view image;
by the computer, causing the x, y, and z stage motors in communication with the holder to move the holder and thereby the gemstone to align each calculated x-y-z coordinate of the inscription spots to a respective laser focusing plane;
by the computer, while causing the x, y, or z stage motor to move the holder and thereby the gemstone, causing the laser to emit a laser beam directed at each respective inscription spot aligned with the laser focusing plane, wherein the laser beam is focused on each respective laser focusing spot by an objective lens, and wherein each respective inscription spot is substantially equally spaced from one another.

2. Wherein the top camera optical filter and side camera optical filter in claim 1 is a bandpass filter, a shortpass filter, or a longpass filter.

3. The method of claim 1 wherein determining the z-offset using the side-view image includes determining a target inscription spot on the girdle of the gemstone to align with the laser focal plane.

4. The method of claim 1 further comprising, by the computer, mapping the gemstone girdle after capturing the top image and the side image of the gemstone;
causing alignment of each of the x,y,z coordinates of each inscription spot, with the laser focal plane by instructing the x-y-z stage motors to move the holder and thereby the gemstone;
wherein for each inscription spot, the x-y stage motor instructions follow a predetermined trajectory path and z stage motor instructions are determined with respect to the girdle profile using the side image.

5. The method of claim 1 wherein the x-y-z coordinates of each inscription spot are pre-determined based on a reference calibrated to a size of the gemstone.

6. The method of claim 1 wherein the laser is a solid-state/excimer laser.

7. The method of claim 1 further comprising, by the computer, modulating each inscription spot by a width by modifying the z-offset by controlling a motorized iris open and close, inserting and optical attenuator module or utilizing a filter in a path of the laser beam.

8. The method of claim 1 further comprising, by the computer, modulating each inscription spot for the inscription by a width by modifying a laser power variation by controlling a motorized iris open and close, inserting an optical attenuator module, or utilizing a filter in a path of the laser.

9. A system for laser inscribing a gemstone, the system comprising:
a computer with a processor and memory, the computer in communication with a first light source and a second light source, at least one motor coupled to a holder configured to hold the gemstone, and a laser generator to create an inscription on the gemstone,
wherein the first light source is configured to be directed at the gemstone in the holder from a side-view;
wherein the second light source is configured to be directed at the gemstone in the holder from a girdle top-view;
a top camera configured with a top camera color filter that only transmit light from the second light source and to capture a top image of the gemstone in the holder;
a side camera configured with a side camera color filter that only transmit light from the first light source and to capture a side image of the gemstone in the holder;
wherein the computer is configured to utilize the captured side image to map a side view girdle profile of the gemstone and calculate a relative motor movement to align each spot along the inscription with a laser focal plane;
wherein the computer is further configured to cause the laser generator to generate a laser beam at the gemstone in the holder, and the relative motor movement of the gemstone in the holder aligns the spots along the inscription at substantially equal spacing from one another along the inscription.
